(19) United States
(12) Patent Application Publication
(10) Pub. No.: US 2007/0129088 A1
(43) Pub. Date: Jun. 7, 2007

(54) Method and system for performing cell reselection during an information transfer

(76) Inventors: Zhou Gao, Lake Zurich, IL (US); Pramod Karnam, Palatine, IL (US); Patrick R. Marcell, St. Charles, IL (US)

Correspondence Address: MOTOROLA, INC., 1303 EAST ALGONQUIN ROAD, IL01/3RD, SCHAUMBURG, IL, 60196, US

(21) Appl. No.: 11/293,915

(22) Filed: Dec. 5, 2005

(51) Int. Cl. H04Q 7/20

(52) U.S. Cl. 455/464

(57) ABSTRACT

A method and a system for performing cell reselection during an information transfer between a mobile device and one or more base stations in a network are provided. The mobile device extracts the RF environment information and sends it to the base station. The base station determines the time at which the cell reselection needs to be performed. The cell reselection is performed, based on the RF environment information, the amount of information that remains to be transferred between the mobile device and the base station, and a pre-defined condition of the information transfer.

### FIELD OF THE INVENTION

The present invention relates generally to wireless communications. More specifically, it relates to cell reselection during an information transfer.

### BACKGROUND OF THE INVENTION

A geographic area may have one or more base stations, each serving a particular geographical area. As a mobile device moves from one geographic area to another, it often becomes necessary for the mobile device to communicate with different base stations. Therefore, there is a need for the mobile device to switch from one base station to another, particularly when the subscriber moves out of the transmission range of a first base station and within the transmission range of a second base station.

The switch from one base station to another is handled in different ways by different types of networks. The manner in which switching is handled depends on the operating mode of the network and/or the type of communication protocol being used.

An example of an operating mode is a Network Control 2 (NC2) operating mode. NC2 is a cell reselection mode in which the network, i.e., the base station, informs the mobile device when it needs to switch to a new base station. For instance, in the example of a General Packet Radio Services (GPRS) network, in which the mobile device is connected to a base station and is downloading information, the information can be downloaded over different protocols, such as the Web Access Protocol (WAP), the Internet Protocol (IP), the Real Time Streaming Protocol (RTSP), etc. When the radio frequency (RF) signal strength deteriorates, the mobile device attempts to establish a new communication connection with a second base station. This cell reselection can result in data loss if the mobile device is in the process of transferring information/data to the first base station.

The NC2 cell reselection procedure enables the mobile device to establish a new logical connection between itself and the second base station, for data transmission to the second base station. However, the new logical connection restarts the process of information transfer to the second base station, which results in time and cost inefficiency.

Hence, there is a need for a technique that will optimize the cell reselection procedure and enable retransmission of data on a new logical connection in a manner that can be implemented with the minimal impact to the existing infrastructure.

### BRIEF DESCRIPTION OF THE DRAWINGS

Various embodiments will hereinafter be described in conjunction with the appended drawings, which are provided to illustrate but not to limit the invention, wherein like designations denote like elements, and in which:

FIG. 1 illustrates an exemplary environment wherein one or more mobile devices are connected to one or more base stations, in accordance with an embodiment of the present invention.

FIG. 2 is a flowchart depicting a method for performing cell reselection during an information transfer, in accordance with an embodiment of the present invention.

FIGS. 3 and 4 show a flowchart depicting a method for performing NC2 cell reselection during a TBF countdown procedure in a UL information transfer, in accordance with another embodiment of the present invention.

FIG. 5 shows a block diagram of a system for performing NC2 cell reselection during a TBF countdown procedure in a UL information transfer, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present invention.

### DETAILED DESCRIPTION OF THE EMBODIMENTS

Various embodiments of the present invention provide a method and a system for performing cell reselection during an information transfer. A mobile device performs cell reselection when Radio Frequency (RF) environment conditions deteriorate and there is a need to switch to a new base station.

Before describing in detail the method for performing cell reselection during information transfer, it should be observed that embodiments of the present invention are focused primarily in the method steps and the apparatus components, which are employed to achieve the cell reselection.

Accordingly, the method steps and apparatus components have been represented where appropriate by conventional symbols in the drawings, showing only those specific details that are pertinent to understanding embodiments of the present invention, so as not to obscure the disclosure with details that will readily be apparent to those of ordinary skill in the art having the benefit of the description herein.

In this document, relational terms such as first and second, and so forth may be used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including” and/or “having”, as used herein, are defined as comprising.

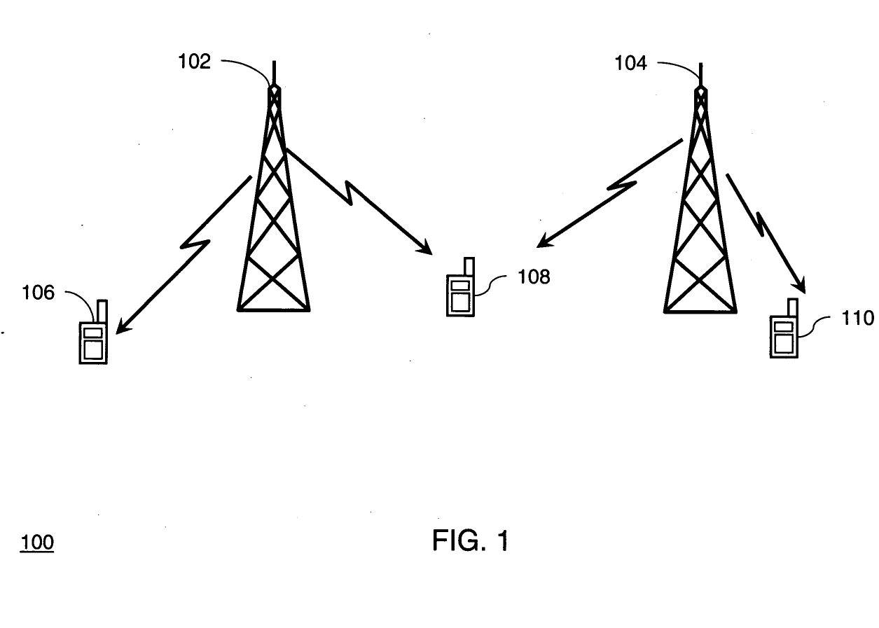

FIG. 1 illustrates an exemplary environment 100 in which one or more mobile devices are connected to one or more base stations, in accordance with an embodiment of the present invention. The environment 100 depicts base stations 102 and 104, which serve a geographical area. Mobile devices 106, 108 and 110 are connected to one or more of the base stations 102 and 104. In an exemplary embodiment of the present invention, each of the mobile devices 106, 108 and 110 are General Packet Radio Service (GPRS) enabled mobile phones exchanging information with the base station. In various other embodiments of the present invention, one or more of the mobile devices 106, 108 and 110 may be a Personal Digital Assistant (PDA), a Smart-phone and so forth. The mobile devices send information to the base stations in the form of an Uplink (UL) information transfer.

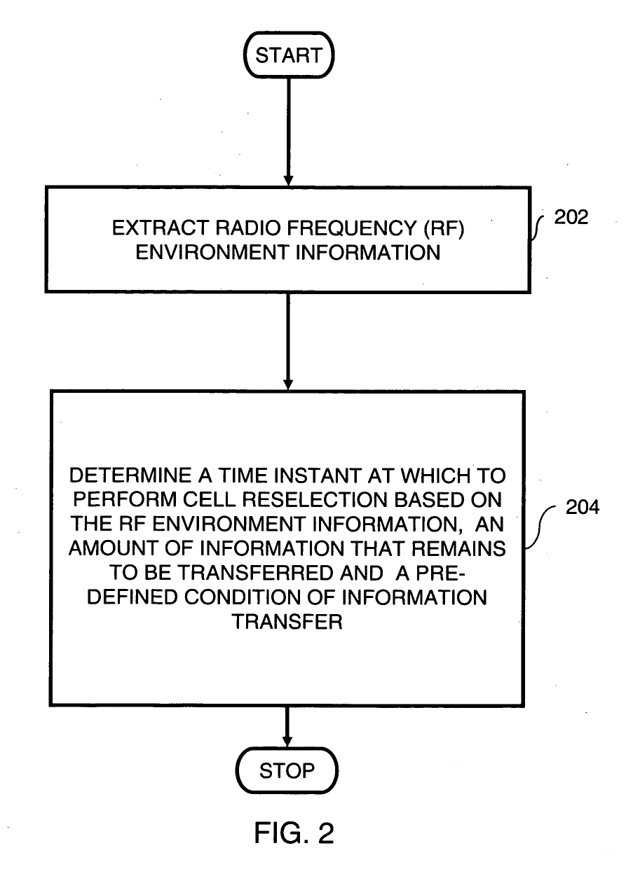

FIG. 2 is a flowchart depicting a method for performing cell reselection during information transfer, in accordance with an embodiment of the present invention. At step 202, the RF environment information is extracted. Examples of RF environment information can include RF receive signal (Rx) information, RF average signal strength (RxLev) information, the pilot channel strength, the ratio of the average power to the total signal power of a channel (Ec/Io) metric, a link frame error rate (FER) metric, a link data rate metric, and so forth.

At step 204, a time instant is determined to perform the cell reselection, based on the RF environment information, a pre-defined condition of the information transfer, interleaving depth information, and the amount of information that remains to be transferred between the mobile device and the base station. In Network Control 2 (NC2) cell reselection, the base station decides the cell reselection and gives directions to the mobile device regarding the cell reselection. The process of cell reselection will hereinafter be referred to as NC2 cell reselection.

In one embodiment, the NC2 cell reselection is performed during the countdown procedure of a Temporary Block Flow (TBF) in an uplink (UL) information transfer. The UL information transfer involves sending information from the mobile device to the base station. The TBF is a logical connection that supports data transmission on physical packet data channels between a sender (such as a mobile device) and a receiver (such as a base station). A TBF is a temporary connection and is maintained only during the data transfer, i.e., until there are no more Radio Link Control (RLC) data blocks to be transmitted. The RLC is a sub-layer of the radio interface, providing reliability in the network by transmitting higher layer Protocol Data Units (PDUs) without adding any control information pertaining to the protocol.

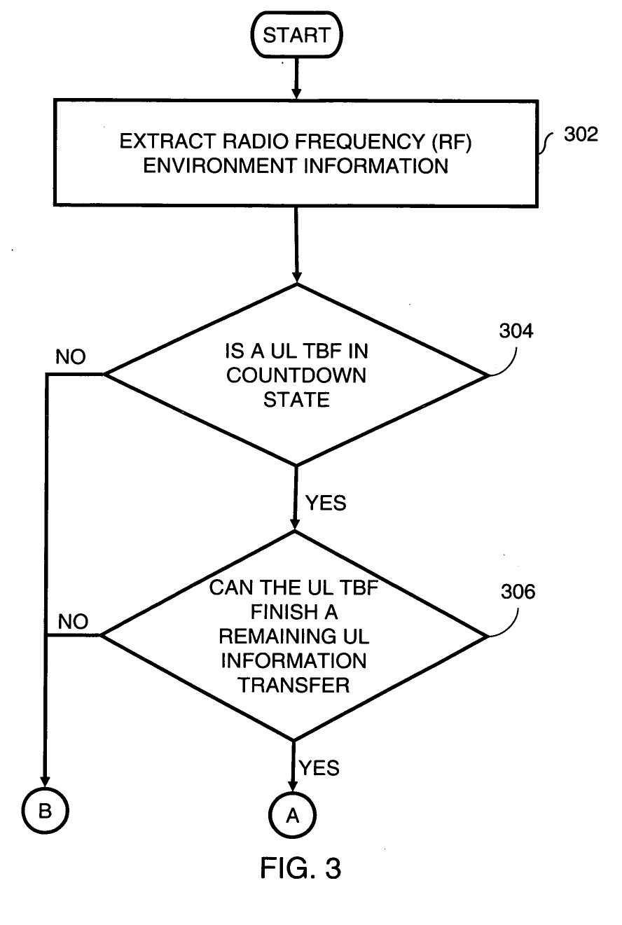

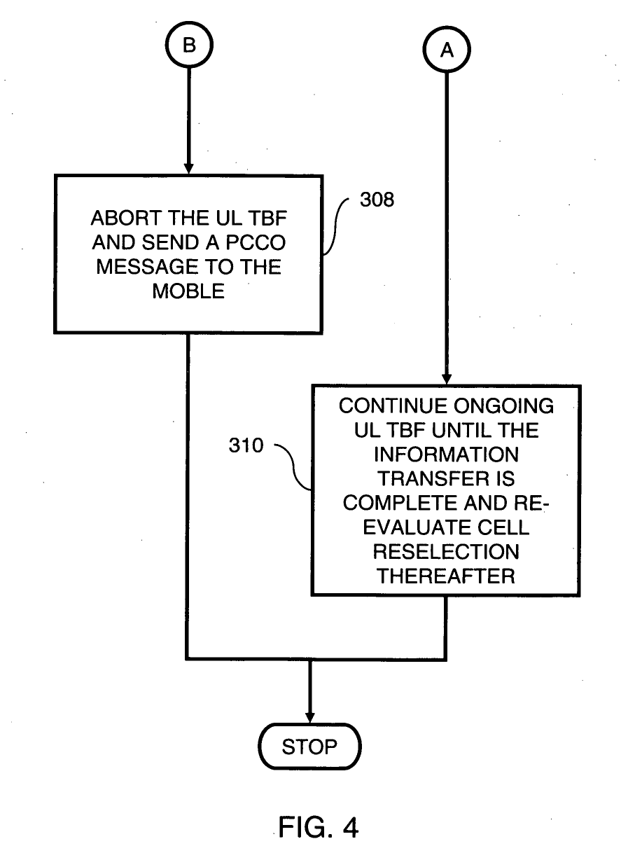

FIGS. 3 and 4 show a flowchart depicting a method for performing NC2 cell reselection during a TBF countdown procedure in a UL information transfer, in accordance with another embodiment of the present invention. The TBF countdown procedure in the UL information transfer will hereinafter be referred to as the UL TBF countdown procedure. The mobile device continuously updates the base station with link strength information for the link between the mobile device and the base station.

At step 302, the mobile extracts RF environment information, based on link strength information, and sends the extracted RF environment information to the base station. For example, the mobile 108 extracts the RF environment information and sends it to the base station 102. Based on the extracted RF environment information, the base station 102 decides whether it is necessary to switch over to second base station 104.

For example, the network may issue an NC2 cell reselection based on many factors such as the following: Rxlev of the serving cell and its neighbors, relative Rxlev required to access the neighbor, and the level of congestion at the neighbor cells. The network may not necessarily perform NC2 even if a target cell Rxlev is stronger than a source cell Rxlev.

In one embodiment of the present invention, the mobile device 108 contacts a Packet Control Unit (PCU), which is logically associated with both base station 102 and 104 in a GPRS network. The PCU is responsible for managing the radio resources of the GPRS network. The radio resources are the resources and/or information, which are transmitted in the network. The PCU is located between the base station and the Serving GPRS Support Node (SGSN). The SGSN keeps track of the location of an individual mobile device, and performs security and access control functions.

At step 304, the base station 102 checks whether the UL TBF is in the countdown state. The UL TBF countdown state is determined by checking the Countdown Value (CV) information in the UL TBF. In an embodiment of the present invention, the CV information is a series of decreasing integer values, which indicate the countdown state of the UL TBF. For example, consider a case in which the CV information starts from CV=6 and keeps on decreasing by one integer value until it reaches a value CV=0, indicating the countdown state of the UL TBF. At the value CV=0, the UL TBF is terminated.

If the UL TBF is in the countdown state, then at step 306 the base station 102 performs a check on whether the UL TBF can complete the remaining UL information transfer. For example, the base station 102 checks the RF Rx information, the interleaving depth information, and the RF RxLev information to decide whether the UL TBF countdown procedure can complete the remaining UL information transfer. The UL information transfer can be measured in terms of the Radio Link Control (RLC) data blocks that still need to be transferred, and the RLC header may contain the CV information.

In an exemplary embodiment of the present invention, when the UL TBF is in the countdown state, the RLC data block count varies from 1 to 15, corresponding to an equivalent time period of 20 milliseconds to 300 milliseconds.

Based on the CV information, if it is found that the UL TBF is not in the countdown state, as checked at step 304, or if the UL TBF countdown procedure cannot complete the remaining UL information transfer, as checked at step 306, then step 308 is performed. At step 308, the UL TBF countdown procedure is aborted and a Packet Cell Change Order (PCCO) message is sent to the mobile device 108.

The PCCO message, when it is received by the mobile 108, initiates the NC2 cell reselection procedure and terminates the UL TBF with the current BTS. For example, when the mobile device 108 receives the PCCO message, the mobile device 108 switches from base station 102 to base station 104 by terminating the UL TBF associated with the base station 102 and establishing a new UL TBF with the base station 104. In an exemplary embodiment, the NC2 cell reselection is initiated when the UL TBF countdown procedure cannot complete the remaining UL information transfer. In this event, a new UL TBF is established after the mobile device 108 has been connected with the base station 104. The information transfer between the mobile 108 and the base station 104 is then re-initiated on the new UL TBF.

Based on the CV information, if it is found that the UL TBF is not in the countdown state, as checked at step 304, and if the UL TBF countdown procedure can complete the remaining UL information transfer, as checked at step 306, then step 310 is performed. At step 310, the UL TBF countdown procedure is allowed to be completed, and the remaining RLC data blocks are transmitted. This provides a smoother transfer of UL information between the mobile device and the base station. The requirement for NC2 cell reselection is checked again, at the step 310, after the information transfer is complete, based on the RF environment information.

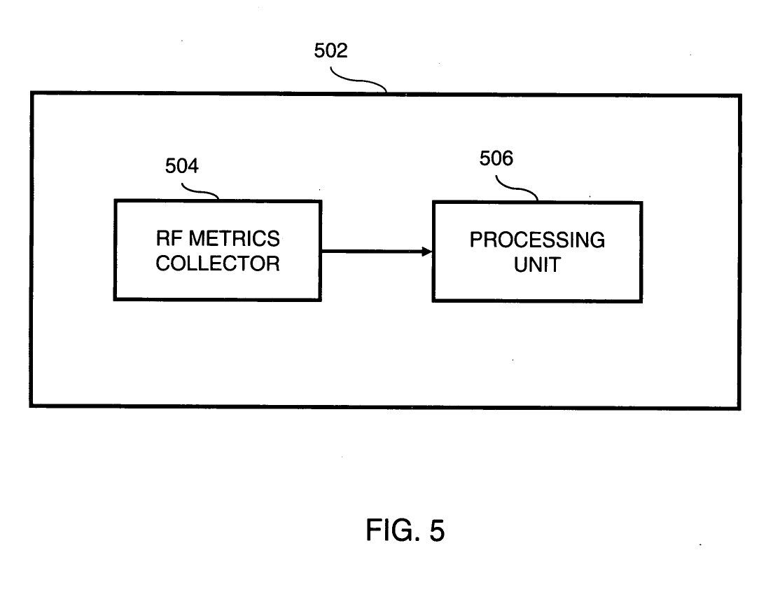

FIG. 5 shows a block diagram of a system for performing NC2 cell reselection during a TBF countdown procedure in a UL information transfer, in accordance with an embodiment of the present invention. The system 502 comprises an RF metrics collector 504 and a processing unit 506. The RF metrics collector 504 extracts the RF environment information from the mobile device. For example, the RF metrics collector 504 extracts the RF Rx information, the RF RxLev information, the pilot channel strength, the Ec/Io metric, the FER metric, and the link data rate metric from the information, which the mobile device 108 tracks and sends to the base station 102 at regular intervals.

The extracted RF environment information is sent to the processing unit 506. The processing unit 506 determines the time when the NC2 cell reselection needs to be performed in an UL information transfer, based on the received RF environment information and the amount of information transfer that remains to be transferred as a part of the UL information transfer.

The processing unit 506 checks whether the UL TBF is in the countdown state. If the UL TBF is not in the countdown state, the processing unit 506 sends the PCCO message to the mobile station 108 to initiate the NC2 cell reselection procedure. The processing unit 506 further checks whether the UL TBF countdown procedure can complete the remaining UL information transfer by checking the CV information. Based on the CV information, if the UL TBF countdown procedure cannot complete the remaining UL information transfer, the processing unit 506 sends the PCCO message to the mobile station 108 for the initiation of the NC2 cell reselection. If the UL TBF countdown procedure can complete the transfer of the remaining UL information, the processing unit 506 delays the NC2 cell reselection and enables the ongoing UL TBF countdown procedure to complete the remaining information transfer. In an exemplary embodiment of the present invention, a PCU comprises the processing unit 506, associated with the base stations 102 and 104.

Other embodiments are implemented using one or more software algorithms in the PCU. The PCU performs the functions of checking the CV information and the UL TBF countdown procedure. Based on the checked CV values, the PCU directs the mobile device to initiate or delay the NC2 cell reselection. The method steps followed by such a PCU are similar to the steps mentioned above in FIGS. 3 and 4.

The present invention provides a method and a system for performing NC2 cell reselection during a TBF countdown procedure involving a UL information transfer. The method facilitates timings in Transmission Control Protocol (TCP) data transfers, for example. TCP is a reliable protocol providing a connection-oriented, point-to-point service. For example, in the case of a TCP data transfer, a TCP acknowledge (ACK) message is associated with the CV=0 value. In this event, initiating the NC2 cell reselection procedure without checking the CV information can result in a delay in the TCP ACK message, and can therefore decrease the TCP data throughput. Embodiments of the present invention delay or avoid the NC2 cell reselection procedure during the UL TBF countdown, and therefore, can improve the TCP data throughput.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for performing cell reselection during an information transfer, the method comprising:
extracting radio frequency (RF) environment information; and
determining a time at which to perform the cell reselection based on the RF environment information, an amount of information that remains to be transferred as part of the information transfer, and a predefined condition of the information transfer.

2. The method of claim 1, wherein the cell reselection is a Network Control (NC2) cell reselection, the NC2 cell reselection being performed during a countdown procedure of Temporary Block Flow (TBF) in an uplink (UL) information transfer.

3. The method of claim 2 further comprising sending a Packet Cell Change Order (PCCO) message to a mobile station for terminating the TBF countdown procedure.

4. The method of claim 2, wherein determining the time at which to perform the cell reselection comprises activating the NC2 cell reselection when the countdown procedure of the TBF is inactive.

5. The method of claim 2, wherein determining the time at which to perform the cell reselection comprises delaying the NC2 cell reselection when the countdown procedure of the TBF is active and the predefined condition of the UL information transfer is satisfied.

6. The method of claim 2, wherein determining the time at which to perform the cell reselection comprises activating the NC2 cell reselection when the countdown procedure of the TBF is inactive and the predefined condition of the UL information transfer is not satisfied.

7. The method of claim 2, wherein the countdown procedure of the TBF further comprises checking a Countdown Value (CV) information in the TBF for determining a remaining time interval for the amount of information that remains to be transferred as part of the UL information transfer of the TBF.

8. The method of claim 7, wherein the predefined condition of the UL information transfer comprises checking whether the amount of information that remains to be transferred as part of the UL information transfer can be completed in the remaining time interval for termination of the TBF.

9. The method of claim 1, wherein the RF environment information comprises at least one of RF receive signal (Rx) information, RF average signal strength (RxLev) information, pilot channel strength, a ratio of average power to total signal power of a channel (Ec/Io) metric, a link frame error rate (FER) metric, and a link data rate metric.

10. A system for performing cell reselection during an information transfer, the system comprising:
a radio frequency (RF) metrics collector adapted to extract the RF environment information; and
a processing unit, communicatively coupled to the RF metrics collector, adapted to determine a time at which to perform the cell reselection based on the RF environment information, an amount of information that remains to be transferred as part of the information transfer, and a predefined condition of the information transfer.

11. The system of claim 10, wherein the cell reselection is a Network Control (NC2) cell reselection, the NC2 cell reselection being performed during a countdown procedure of Temporary Block Flow (TBF) in an uplink (UL) information transfer.

12. The system of claim 11 wherein the processing unit is further adapted for sending a Packet Cell Change Order (PCCO) message to a mobile station for terminating the TBF countdown procedure.

13. The system of claim 11, wherein the processing unit is further adapted for activating the NC2 cell reselection when the countdown procedure of the TBF is inactive.

14. The system of claim 11, wherein the processing unit is further adapted for delaying the NC2 cell reselection when the countdown procedure of the TBF is active and the predefined condition of the UL information transfer is satisfied.

15. The system of claim 11, wherein the processing unit is further adapted for activating the NC2 cell reselection when the countdown procedure of the TBF is inactive and the predefined condition of the UL information transfer is not satisfied.

16. The system of claim 11, wherein the processing unit is further adapted for checking a Countdown Value (CV) information in the TBF for determining a remaining time interval for the amount of information that remains to be transferred as part of the UL information transfer of the TBF.

17. The system of claim 16, wherein the predefined condition of the UL information transfer comprises checking whether the amount of information that remains to be transferred as part of the UL information transfer can be completed in the remaining time interval for termination of the TBF.

18. The system of claim 10, wherein the RF environment information comprises at least one of RF receive signal (Rx) information, RF average signal strength (RxLev) information, pilot channel strength, a ratio of average power to total signal power of a channel (Ec/Io) metric, a link frame error rate (FER) metric, and a link data rate metric.

19. A computer program product performing cell reselection during an information transfer, the computer program product performing:
extracting radio frequency (RF) environment information; and
determining a time at which to perform the cell reselection based on the RF environment information, an amount of information that remains to be transferred as part of the information transfer, and a predefined condition of the information transfer.

20. The computer program product of claim 19, wherein the cell reselection is a Network Control (NC2) cell reselection, the NC2 cell reselection being performed during a countdown procedure of Temporary Block Flow (TBF) in an uplink (UL) information transfer.

21. The computer program product of claim 20 further comprising sending a Packet Cell Change Order (PCCO) message to a mobile station for terminating the TBF countdown procedure.

22. The computer program product of claim 20, wherein determining the time at which to perform the cell reselection comprises activating the NC2 cell reselection.

23. The computer program product of claim 20, wherein determining the time at which to perform the cell reselection comprises delaying the NC2 cell reselection.

24. The computer program product of claim 20, wherein the countdown procedure of the TBF further comprises checking a Countdown Value (CV) information in the TBF for determining a remaining time interval for the amount of information that remains to be transferred as part of the UL information transfer of the TBF.

25. The computer program product of claim 19, wherein the RF environment information comprises at least one of RF receive signal (Rx) information, interleaving depth information, and RF average signal strength (RxLev) information.
